(19) United States
(12) Patent Application Publication
(10) Pub. No.: US 2017/0370003 A1
(43) Pub. Date: Dec. 28, 2017

(54) METHOD FOR MANUFACTURING A METAL COMPONENT, METAL COMPONENT, AND TURBOCHARGER

(71) Applicant: BorgWarner Inc., Auburn Hills, MI (US)

(72) Inventors: Gerald SCHALL, Bobenheim-Roxheim (DE); Daniela CEMPIRKOVA, Bolanden (DE); Hermann H. URLBERGER, Ratingen (DE); Alexander DONCHEV, Schoeneck (DE)

(21) Appl. No.: 15/548,107

(22) PCT Filed: Jan. 21, 2016
(86) PCT No.: PCT/US2016/014207

§ 371 Date: Aug. 2, 2017

(30) Foreign Application Priority Data
Feb. 3, 2015 (DE) 102015201846.6

(51) Int. Cl. C23C 18/18; F04D 29/28; C23C 18/16; C23F 1/36; C23C 18/32; F04D 29/02; F02C 6/12

(52) U.S. Cl. CPC C23C 18/1827; C23C 18/32; F04D 29/284; F04D 29/023; C23C 18/1637; C23F 1/36; F05D 2220/40; F02C 6/12

(57) ABSTRACT

A turbocharger compressor wheel with an aluminum proportion of at least 50 atom percent, produced by. etching a turbine wheel base body using an alkaline etchant to produce a specific etch pitting consisting of nano pores and micropores and chemical deposition of a nickel-phosphorous protective layer (19) onto the etched base body surface.

The invention relates to a method for manufacturing a metal component according to the preamble of claim 1. The invention further relates to a metal component and to a turbocharger which comprises a metal component of this type.

In the automobile industry, chemical deposition, that is electroless deposition of nickel-phosphorous coatings, is often used as protection against corrosion or as protection against wear of metal components, for example pistons, ball joints, fuel lines, and the like. The chemical deposition of a nickel-phosphorous protective coating enables a uniform formation of layers; however, it requires a surface free of defects. Otherwise, deficiencies in the adhesion of the coating to the material occur, uneven coating thicknesses are formed, and the visual appearance of the coating is impaired.

It is therefore the object of the present invention to specify a method for manufacturing an aluminous metal component which may be realized without high technical expenses, and which enables the forming of a uniform and homogeneous, nickel surface layer with good adhesion and high contour fidelity. It is further the object of the present invention to provide an aluminous metal component and a turbocharger comprising a metal component of this type, which is characterized by a uniformly formed nickel protective layer with good adhesion.

The solution to these problems is carried out by the features of claims 1, 11, and 16.

According to the invention, a method is claimed for manufacturing a metal component with an aluminum proportion of more than 50 atom percent which is protected from corrosion and environmental influences as well as operating conditions. The metal component is in particular a compressor wheel for a turbocharger. Essential to the invention is hereby the chemical pretreatment provided for the workpiece, namely an etching of the metal component using an alkaline etchant E6. The etching with the alkaline etchant E6 causes a consistent surface with high finish quality, in particular, a specific etch pitting is generated on the surface of the metal component by using this etchant. It is understood that etch pittings are formed, distributed across the total surface of the metal component, that is indentations which function as the adhesive base for the nickel-containing coating which is chemically applied later. Through selective dissolving of primary aluminum from the metal component surface, the alkaline etchant generates nano etch pittings, that is, indentations with a depth of 0.1 to 1.5 μm, and micro etch pittings, that is, indentations with a depth of 4 to 12 μm. By this means, an increased adhesive surface is generated without impinging on the visual appearance or function of the metal component. In particular, a mechanical interlocking or mechanical shaped connection occurs, in addition to an atomic linking of the corresponding materials, between the metal component surface and the nickel-containing coating during the chemical deposition of the nickel-containing coating on the etched metal component surface, due to the generation of the nano etching pittings. The etch pittings and the coating engage with each other, wherein the coating functions as a type of corset which stabilizes the compound of the metal component nickel-containing protective layer and thus develops a permanent protective effect. The etching and deposition of the nickel-containing layer may be carried out using standard processes without high technical expenses and with low time requirements, so that a metal component with high chemical resistance, high mechanical strength, and very good corrosion protection may be manufactured by the method according to the invention.

The subclaims have preferred refinements and embodiments of the invention as their subject matter.

According to a preferred embodiment of the method according to the invention, the etching is carried out in an etching bath. Thus, the metal component may be uniformly pretreated on all surface areas and provided with etch pittings within a short reaction time.

The reaction time for the etching may thereby be reduced in particular by conditioning the etching bath. A temperature of the etching bath lies preferably between 50 and 80° C. and in particular between 55 and 65° C.

A high proportion of nano etch pittings, which is especially advantageous for a good adhesion of the coating to be applied later to the metal component surface, is achieved in particular in that an immersion time is maintained of the metal component into the etching bath, which lies between 20 and 40 seconds, and in particular is approximately 30 seconds. Substantially longer immersion times increase the proportion of micro etch pittings and are thus less preferable. The immersion time is thereby the time which is used for the immersion, and thus the introduction of the metal component into the etching bath.

For the previously stated reason, a dwell time of the metal component in the etching bath of 60 to 110 seconds, and in particular of 85 to 95 seconds is preferred. A dwell time in the context of the invention is thereby understood as the time during which the metal component remains in the etching bath.

The dwell time is followed by the emersion time, which lies advantageously in particular between 20 and 40 seconds, and in particular at approximately 30 seconds. The emersion time includes the time frame from the beginning of the emersion of the metal component out of the etching bath to the complete emersion of the metal component out of the etching bath.

The ratio of formation of micro etch pittings to nano etch pittings may be influenced in particular by appropriate variations of the dwell time and emersion time. The dwell time, in particular, plays a large role herein.

An especially uniform etching of the metal component surface is achieved in that the metal component is moved in a radially extending circular path in the etching bath. It is hereby additionally advantageous if the movement direction is reversible. These method steps have proven themselves in particular in the manufacture of a compressor wheel for a turbocharger. The etching and thus also the subsequent coating are especially uniformly developed by the rotational movement in both directions, such that the compressor wheel no longer needs to be rebalanced. The acoustic behavior of the turbocharger is thus improved without additional post-treatment of the compressor wheel by carrying out a rebalancing.

A rotational speed of the metal component in the etching bath is advantageously 10-15 rpm. Thus, a particularly uniform flow of the etching composition is promoted at the component, and additionally a good dissolving and removal of surface pieces removed from the metal component. In addition, a formation of zincate barriers or oxygen barriers may be prevented especially well by the dynamic movement of the metal component in the etching bath.

By using a coating composition which contains nickel ions, more than 10.3 wt. % and in particular more than 10.5 wt. % phosphorous, and more than 0.3 wt. % antimony, wherein the percent values are relative in each case to the total weight of the coating composition, a highly stabile coating is achieved. By this means, a high micro elongation of 1.1 to 2% is achieved on the one hand, in particular by the high phosphorous proportion, which enables an excellent adhesion of the coating to the metal component surface, even under the effects of high centrifugal forces such as occur, for example, during operation of a compressor wheel. The micro elongation is thereby determined by Erichsen cupping. On the other hand, a zincate distribution on the surface is dissolved by the coating composition. The charge exchange to be set thus leads to the seeding of the treated metal component surface with nickel seeds which then subsequently introduce the autocatalysis and thus maintain a progression of the coating reaction.

Preferably, a maximum proportion of antimony in the coating composition is 0.5 wt. % relative to the total weight of the coating composition.

In particular, in the manufacture of a compression wheel, a further advantage arises by using the previously mentioned coating composition in combination with the generation of nano etch pittings by using the alkaline etchant E6: the natural frequency of the compressor wheel is increased by 2%. By this means, unexpectedly high power reserves become accessible in the upper rotational speed range.

The surface qualities of the metal component may be further improved in that the metal component is pretreated with a solution containing saltpeter acid before the chemical deposition of the nickel-containing coating.

The metal component is advantageously formed from an aluminum alloy, in particular a heat-resistant aluminum alloy. In addition to aluminum, further alloy components may be selected in particular from: silicon (Si), iron (Fe), copper (Cu), manganese (Mn), magnesium (Mg), nickel (Ni), zinc (Zn), and titanium (Ti), as well as mixtures of the same. The content of the previously listed alloy components is, relative to the total alloy, advantageously less than 3 wt. % in each case. The metal component is preferably formed from the material AlCuMgNi or from AlCu₂MgNi. The previously disclosed method is therefore suited particularly well for the manufacture of AlCuMgNi components and AlCu₂MgNi components. This is traced back in particular to the fact that the alkaline etchant E6 etches very selectively. In the case of AlCuMgNi or AlCu₂MgNi, this means that only primary aluminum, Fe—Cu—Ni precipitation phases and MgSi₂ precipitation phases are dissolved. This results in a particularly high proportion of nano etch pittings and thus to an especially good mechanical interlocking of the subsequently deposited nickel-containing coating in the etch pittings of the etched metal component. Even complex components may thus be coated highly precisely. The copper contained in the workpiece thereby additionally supports the formation of nano etch pittings since it remains at the surface of the metal component during the etching and reduces the etching intensity by occupying surface locations. The copper may be removed prior to the coating, for example, by treatment with saltpeter acid solution.

A particularly preferred material for the metal component according to the invention has the following composition: 0.1-0.3 Wt. % Si, 0.7-1.7 Wt. % Fe, 1.6-2.9 Wt. % Cu, 0-0.25 Wt. % Mn, 1.1-1.9 Wt. % Mg, 0.7-1.5 Wt. % Ni, 0-0.15 Wt. % Zn, 0-0.25 Wt. % Ti, and Al, where Al functions for balancing. A metal component made from the above material is characterized by very good mechanical characteristics.

Likewise according to the invention, a metal component is also described with an aluminum proportion of at least 50 atom percent, which is designed in particular as a compressor wheel for a turbocharger. The metal component has a nickel-containing coating with good adhesion, which contains nickel, more than 10.3 wt. % and in particular more than 10.5 wt. % phosphorous, and more than 0.3 wt. % antimony. The indications of quantity refer in each case to the total weight of the coating. The metal component may be manufactured in particular according to the previously disclosed method and is characterized by a high surface quality with excellent mechanical fixing of the nickel-containing coating in the metal component surface, which withstands high mechanical and strong chemical loads even under operating conditions or application conditions of the metal component.

The previously listed advantages of the method according to the invention, advantageous effects, and refinements are also applied to the metal component according to the invention.

In the light of a high surface quality, the coating advantageously has a layer thickness tolerance of maximum±1.5 μm at a layer thickness of approximately 20 μm. This contributes in particular to a noise reduction of the compressor wheel.

A particularly good adhesion of the coating to the metal component surface is achieved in that the surface of the metal coating has first indentations with a depth of 0.1 to 1.5 μm. These indentations may be generated by etching with an alkaline etchant E6 and are also designated as nano etch pittings.

The first indentations contribute to a surface increase which functions as an adhesive base for the coating such that a particularly good mechanical fixing may be obtained of the nickel-containing layer on the metal component surface.

Further advantageously, the surface of the metal component may have second indentations (micro etch pittings) with a depth of 4 to 12 μm.

For a permanent and mechanically highly stressable coating of the metal component, even at the effects of high centrifugal forces, a volume ratio of the first indentations to the second indentations is 15:1 to 20:1, relative to the total volume of first indentations and second indentations.

In addition, a turbocharger is described as an independently-treated subject matter, which comprises a metal component as previously disclosed, in particular a metal component designed as a compressor wheel.

The advantages listed for the method according to the invention, advantageous effects, and refinements, are also used in the metal component according to the invention and the turbocharger according to the invention.

Additional details, advantages, and features of the present invention arise from the subsequent description of embodiments by means of the drawings.

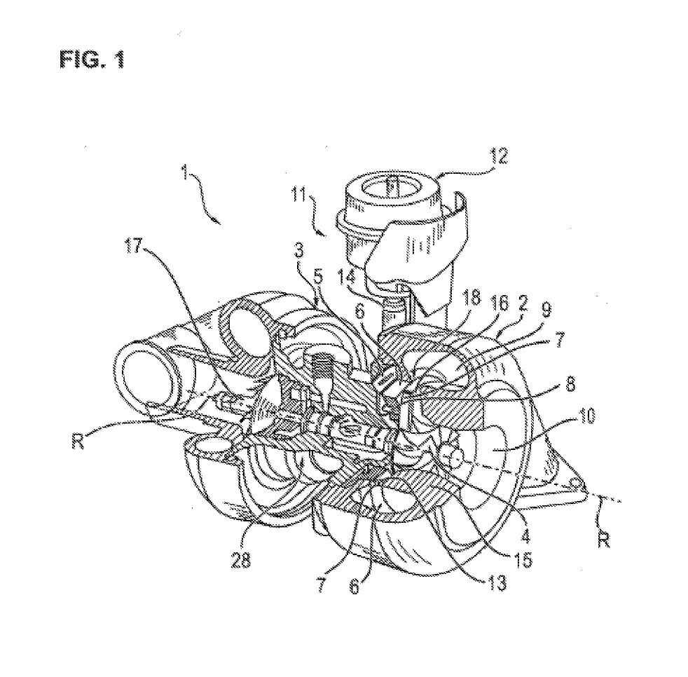

FIG. 1 shows a partial sectional view of a turbocharger according to one embodiment of the invention,

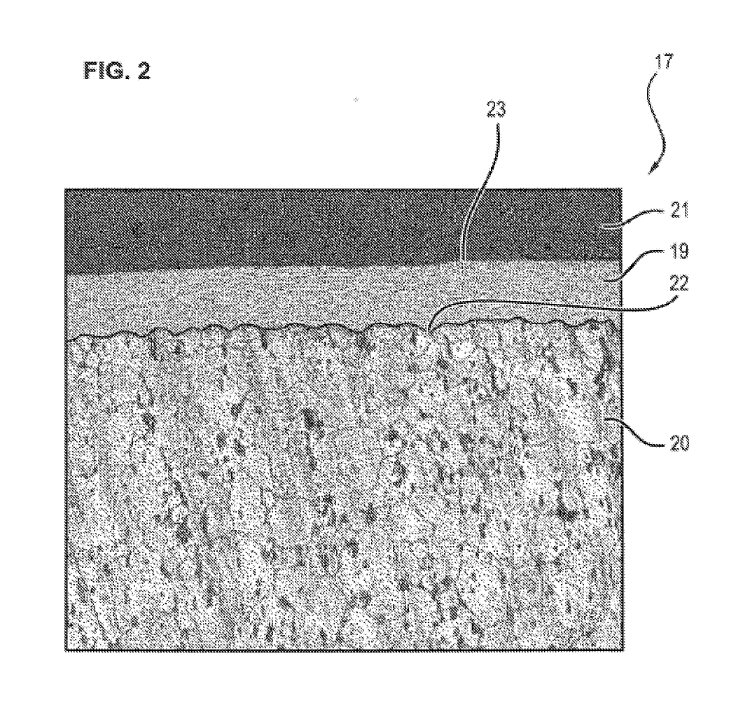

FIG. 2 shows a microscopic sectional view of a section of a metal component according to one embodiment of the invention, and

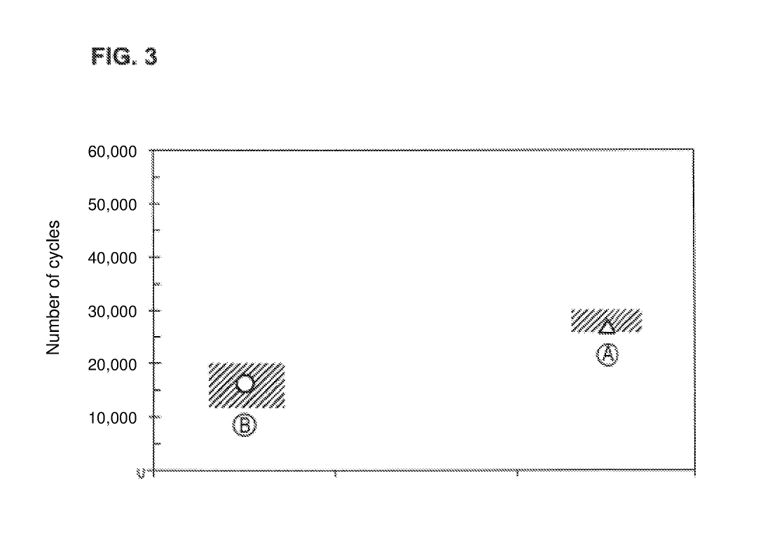

FIG. 3 shows a diagram to illustrate the mechanical strength of the metal component according to the invention from FIG. 2.

FIG. 1 shows a perspective view presented with partial cut aways of an exhaust gas turbocharger according to one embodiment of the invention. A turbocharger 1 is depicted in FIG. 1 which has a turbine housing 2 and a compressor housing 3 connected thereto via a bearing housing 28. Housings 2, 3, and 28 are arranged along an axis of rotation R. The turbine housing is shown with partial cut aways in order to clarify the arrangement of a blade bearing ring 6 and a guide baffle 18 formed radially outwardly by the same and which has a plurality of guide vanes 7 distributed across the circumference, and the guide vanes have pivot axes 8. By this means, nozzle cross sections are formed which are larger or smaller according to the position of guide vanes 7 and which impinge turbine wheel 4, mounted in the center at axis of rotation R, with more or less exhaust gas of an engine supplied via a supply channel 9 and discharged via a central nozzle 10 in order to drive compressor wheel 17 seated above turbine wheel 4 on the same shaft.

In order to control the movements or the position of guide vanes 7, an actuation unit 11 is provided. This may be designed in any way, for example in the form of a control housing 12 which controls the control movement of a tappet part 14 fixed to it in order to convert the movement of the tappet part on an adjustment ring or holding ring 5, mounted behind the blade bearing ring 6, into a slight rotational movement of the adjustment ring or holding ring. A clearance 13 for guide vanes 7 is formed between blade bearing ring 6 and an annular part 15 of turbine housing 2. In order to be able to ensure this clearance 13, blade bearing ring 6 has spacers 16.

Compressor wheel 17 is a metal component in the context of the present invention and is formed from a metal material which contains at least 50 atom percent aluminum. Compressor wheel 17 has a nickel-containing coating 19. Nickel-containing coating 19 contains nickel, more than 10.3 wt. % phosphorous, and more than 0.3 wt. % antimony, in each case relative to the total weight of coating 19. Indentations are formed at the surface of compressor wheel 17, so-called etch pittings which were obtained by corresponding chemical pretreatment of compressor wheel 17 prior to the application of nickel-containing coating 19, for optimizing the adhesion of nickel-containing coating 19.

FIG. 2 shows in detail a microscopic sectional view of a section of a metal component, more exactly, a section of a compressor wheel 17 according to one embodiment of the invention. For this purpose, a piece of compressor wheel 17 was embedded in an embedding means 21 and examined (microsection examination) by means of scanning electron microscopy (SEM) at a 500× magnification. The reference numeral 20 thereby stands for the metal material, thus a material comprising at least 50 atom percent aluminum. The material is in particular a heat resistant AlCuMgNi or AlCu₂MgNi material.

To manufacture compressor wheel 17, a compressor wheel manufactured from the AlCu₂MgNi material was etched using an alkaline etchant E6 and a nickel-containing layer 19 was subsequently chemically deposited on the surface of compressor wheel 17. During the etching process, compressor wheel 17 was moved in a radially extending circular path and periodically reversed in its movement direction.

Due to the etching with selectively effective etchant E6, etch pittings were formed on the surface of the AlCu₂MgNi material. These are indentations which are formed by dissolving primary aluminum and Fe—Cu—Ni precipitation phases and MgSi₂ precipitation phases. Among the indentations are those with a depth of 0.1 to 1.5 μm, so-called nano etch pittings 22, and those with a depth of 4 to 12 μm, so-called micro etch pittings. The proportion of nano etch pittings 22 is thereby decisively relevant for a good adhesion of coating 19 to the surface of metal component 20.

FIG. 2 shows that nano etch pittings 22 are formed across the entire metal material surface. Nickel-containing coating 19 has sunken into these indentations. Since nano etch pittings 22 have a very small maximum depth, namely a maximum of 1.5 μm, surface 23 of compressor wheel 17 contacting the surroundings of compression wheel 17 is not deformed by the sinking in of coating 19. The surface quality of compressor wheel 17 is thus high.

Nickel-containing coating 19 contains nickel, more than 10.3 wt. % phosphorous, and more than 0.3 wt. % antimony (maximum 0.5 wt. % Sb), in each case relative to the total weight of coating 19. Coating 19 causes a type of corset effect and adheres very well to metal component 20. The layer thickness was 23 to 28 μm at a layer thickness tolerance of maximum±1.5 μm.

Compressor wheel 17 was examined for its mechanical strength.

It was shown hereby that a natural frequency of compressor wheel 17 is increased by 2% in comparison to conventional compressor wheels. This is traced back to the corset effect of nickel-containing coating 19 and the very good interlocking of nickel-containing coating 19 in nano etch pittings 22. Due to the higher natural frequency, unexpectedly high power reserves become accessible in the upper rotational speed range.

Due to the etching with alkaline etchant E6, which is carried out in an etching bath at a temperature of from 55 to 65° C., an immersion time of approximately 30 seconds, a dwell time of approximately 85 to 95 seconds, and an emersion time of approximately 30 seconds, a uniform distribution of etch pittings is obtained which induces macrogeometrically only marginal changes across the total surface, such that following the coating, a rebalancing of compressor wheel 17 may be omitted. By this means, not only costs may be reduced, but flaws in the coating generated by milling during rebalancing are also prevented. By this means, a permanently stable nickel-containing coating 19 was obtained which also had a very good corrosion resistance even after longer usage of compressor wheel 17.

The advantageous features of compressor wheel 17 manufactured according to the invention manifested particularly impressively in a so-called spin test. The results of the spin test are presented in the form of a diagram in FIG. 3.

In the spin test, the compressor wheel, whose microscopic structure is depicted in FIG. 2, was accelerated from 20,000 rpm (revolutions per minute) to 250,000 rpm in a test frame by means of a drive and compressor wheel receiver. This corresponds to one cycle. 10 correspondingly manufactured compressor wheels were examined and the lifecycle results are summarized in FIG. 3 as Result A. A lifecycle for compressor wheel 17 according to the invention was between 27,000 and 30,000 cycles, thus an average of approximately 28,500 cycles. For conventional compressor wheels without the coating applied according to the invention, for example with an electroplated nickel layer, a lifecycle resulted between 11,000 and 18,000 cycles, thus an average of approximately 14,250 cycles (see Result B in FIG. 3). The lifecycle of compressor wheel 17 was thus significantly increased using the coating according to the invention by almost 100%.

The following validation tests had likewise good results:
Outdoor weathering test
Climatic change test
Bombardment test with dust particles at average rotational speed
Scratch test
Flexural strength test for determining the adhesion and confirming the stability of the coating adhesion

The hardness of compressor wheel 17 was between 550 HV and 650 HV.

In addition to the present written description of the invention, explicit reference is made hereby to the illustrated depiction of the invention in FIGS. 1 through 3 as a supplemental disclosure thereto.

### LIST OF REFERENCE NUMERALS

1 Turbocharger
2 Turbine housing
3 Compressor housing
4 Turbine wheel
5 Adjustment ring or holding ring
6 Blade bearing ring
7 Guide vanes
8 Pivot axes
9 Supply channel
10 Axial nozzle
11 Actuation unit
12 Control housing
13 Clearance for guide vanes 7
14 Tappet part
15 Annular part of the turbine housing 2
16 Spacer/distance cam
17 Compressor wheel
18 Guide baffle
19 Nickel-containing coating
20 Metal component
21 Embedding means
22 Nano etch pittings
23 Surface of the nickel-containing coating
28 Bearing housing
R Axis of rotation

1. A method for manufacturing a compressor wheel (17) for a turbocharger (1), the compressor wheel (17) comprising a base body and a nickel-phosphorous protective coating, the method comprising the steps:
etching the base body using an alkaline etchant to produce a specific etch pitting, wherein said specific etch pitting consists of nano etch pittings and micro etch pittings, wherein the nano etch pittings have a depth of 0.1 to 1.5 μm and micro etch pittings have a depth of 4 to 12 μm, and
chemical deposition of a nickel-phosphorous protective layer (19) onto the etched metal surface, wherein the nickel-phosphorous protective layer comprises phosphorous, antimony and nickel.

2. The method according to claim 1, wherein the etching is carried out in an etching bath.

3. The method according to claim 2, wherein a temperature of the etching bath lies between 50 and 80° C.

4. The method according to claim 2, wherein an immersion time of the base body into the etching bath is between 20 and 40 seconds.

5. The method according to claim 2, wherein a dwell time of the base body in the etching bath is 60 to 110 seconds.

6. The method according to claim 2, wherein the base body is moved in the etching bath in a radially extending circular path.

7. The method according to claim 6, wherein a rotational speed of the base body in the etching bath is 10-15 rpm.

8. The method according to claim 1, wherein a coating composition is used for the chemical deposition which contains nickel ions, more than 10.3 wt. %, of phosphorous, and more than 0.3 wt. % of antimony, maximum 0.5 wt. % antimony, in each case relative to the total weight of the coating composition.

9. The method according to claim 1, wherein the base body is treated with a nitric acid solution prior to the chemical deposition of the nickel-containing layer.

10. The method according to claim 1, wherein the base body is formed from AlCuMgNi or AlCu₂MgNi.

11. A compressor wheel (17) for a turbocharger (1), the compressor wheel (17) having a base body and a nickel-phosphorous protective coating (19), the base body having an aluminum proportion of at least 50 atom percent, the base body having a specific etch pitting, wherein said specific etch pitting consists of nano etch pittings and micro etch pittings, wherein the nano etch pittings have a depth of 0.1 to 1.5 μm and micro etch pittings have a depth of 4 to 12 μm, and wherein the nickel-phosphorous protective coating (19) contains nickel, phosphorous, and more than 0.3 wt. % of antimony relative to the total weight of the coating composition.

12. The compressor wheel according to claim 11, wherein the coating (19) has a layer thickness variation of maximum±1.5 μm and a layer thickness of the coating (19) of approximately 20 μm.

13. (canceled)

14. (canceled)

15. The compressor wheel according to claim 11, wherein a volume ratio of the nano pittings to the micro pittings is 15:1 through 20:1.

16. A turbocharger comprising the compressor wheel according to claim 11.

17. A compressor wheel according to claim 11, wherein the coating composition is comprised of more than 10.3 wt. % phosphorous, and more than 0.3 wt. % of antimony, balance nickel, in case relative to the total weight of the coating composition.

18. A compressor wheel according to claim 11, wherein the coating composition is comprised of more than 10.5 wt. % phosphorous, and more than 0.3 wt. % but maximum 0.5 wt % antimony, balance nickel, in each case relative to the total weight of the coating composition.
